(19) United States
(12) Patent Application Publication
(10) Pub. No.: US 2013/0048439 A1
(43) Pub. Date: Feb. 28, 2013

(54) Wheel Chock with Cable Guide

(71) Applicant: Lloyd Marcum, San Luis Obispo, CA (US)

(72) Inventor: Lloyd Marcum, San Luis Obispo, CA (US)

(21) Appl. No.: 13/215,428

(22) Filed: Aug. 23, 2011

(51) Int. Cl. B60T 3/00

(52) U.S. Cl. 188/32

(57) ABSTRACT

A wheel chock having a main body including an inclined tire engaging face, an auxiliary tire engaging face, a base, an upright back wall and at least one conduit dimensioned to receive an electrical cable therethrough. The wheel chock is configured to prevent removal of the electrical cable when a tire of a vehicle is positioned upon at least the auxiliary tire engaging face which anchors the wheel chock upon a support surface.

### CROSS-REFERENCE TO RELATED APPLICATIONS

This application is a related application of co-pending design patent application 29/391,414 filed May 9, 2011 to the instant inventor, said design application is hereby incorporated by reference as if fully set forth herein.

### RELEVANT FIELD

This application is directed generally toward wheeled vehicle accessories and more specifically toward a wheel chock.

### RELEVANT ART

Plug-in electric hybrid/ICE powered vehicles and battery powered vehicles are becoming popular as a fuel efficient and environmentally sound alternative to internal combustion engines (ICE). Many of these electrically powered vehicles require connection to an external electrical power source to recharge and/or maintain onboard batteries at a suitable level of charge. Recharging of the onboard batteries is usually accomplished by way of electrical cables which convey electrical current from an external source to the onboard batteries. These electrical cables tend to be expensive and specific to a particular vehicle manufacturer.

As public recharging facilities become more common, the use of these facilities exposes the electrical cables to loss or theft if left unattended. Accordingly, there is a need in the relevant art to provide a mechanism to secure the electrical cables.

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

### SUMMARY

In view of the foregoing, various embodiments of a wheel chock adapted to retain an electrical cable using a weighted tire to anchor the wheel chock against a support surface are disclosed herein. In an embodiment, the wheel chock comprises a main body having a base, an inclined tire engaging face, an upright back wall coupled with the base and the inclined tire engaging face and an auxiliary tire engaging face extending outwardly from the inclined tire engaging face opposite the upright back wall. The auxiliary tire engaging face is aligned in a plane which parallels the base and a conduit dimensioned to receive an electrical cable. The electrical cable may be a recharging cable associated with a plug-in electric hybrid/ICE powered vehicle and/or an electrically powered vehicle.

One or more conduits may be formed within the main body such that at least a portion of the electrical cable when disposed therethrough is prevented from being removed from the wheel chock when a tire of a vehicle is positioned at least upon the auxiliary tire engaging face. The vehicle tire anchors the wheel chock encompassing a portion of the electrical cable against the support surface, usually a floor, pavement or ground.

The conduit(s) may be formed as channel(s) within the main body or along the base. The channel(s) may include a semi-circular cross-sectional profile dimensioned to substantially encompass the electrical cable therein. The semi-circular cross-sectional profile may form an archway dimensioned to encompass the electrical cable disposed therethrough in cooperation with the support surface, for example the floor, pavement or ground surface.

The wheel chock may be constructed from any suitable rigid material, so long as the construction material is sufficiently rugged to support the weight of the tire and proportional vehicle weight without substantial compression or deformation which could damage the portion of the electrical cable encompassed therein.

### BRIEF DESCRIPTION OF DRAWINGS

The features and advantages of the various inventive embodiments will become apparent from the following detailed description when considered in conjunction with the accompanying drawings. Where possible, the same reference numerals and characters are used to denote like features, elements, components or portions of the inventive embodiments. It is intended that changes and modifications can be made to the described embodiments without departing from the true scope and spirit of the inventive embodiments as is defined by the claims.

FIG. 1—depicts a perspective view of a wheel chock in accordance with an inventive embodiment.

FIG. 2—depicts a side view of a wheel chock in accordance with an inventive embodiment.

FIG. 2A—depicts a first end view of a wheel chock in accordance with an inventive embodiment.

FIG. 2B—depicts a second end view of a wheel chock in accordance with an inventive embodiment.

FIG. 3—depicts a top view of a wheel chock in accordance with an inventive embodiment.

FIG. 4—depicts a bottom view of a wheel chock in accordance with an inventive embodiment.

FIG. 5—depicts a perspective view of a wheel chock when a tire of a vehicle is positioned on a portion thereon.

FIG. 5A—depicts a close-up perspective view of a wheel chock when a tire of a vehicle is positioned on a portion thereon in transverse orientation.

FIG. 5B—depicts a close-up perspective view of a wheel chock when a tire of a vehicle is positioned on a portion thereon in parallel orientation.

### DETAILED DESCRIPTION

Various inventive embodiments of a wheel chock are disclosed herein. In the following detailed description, numerous specific details are set forth in order to provide a thorough understanding of the present inventive embodiments. It will be apparent, however, to one skilled in the art that the present inventive embodiments may be practiced without these specific details. In other instances, well-known structures, construction materials and/or shapes may be shown in block diagram form in order to avoid unnecessarily obscuring the present inventive embodiments.

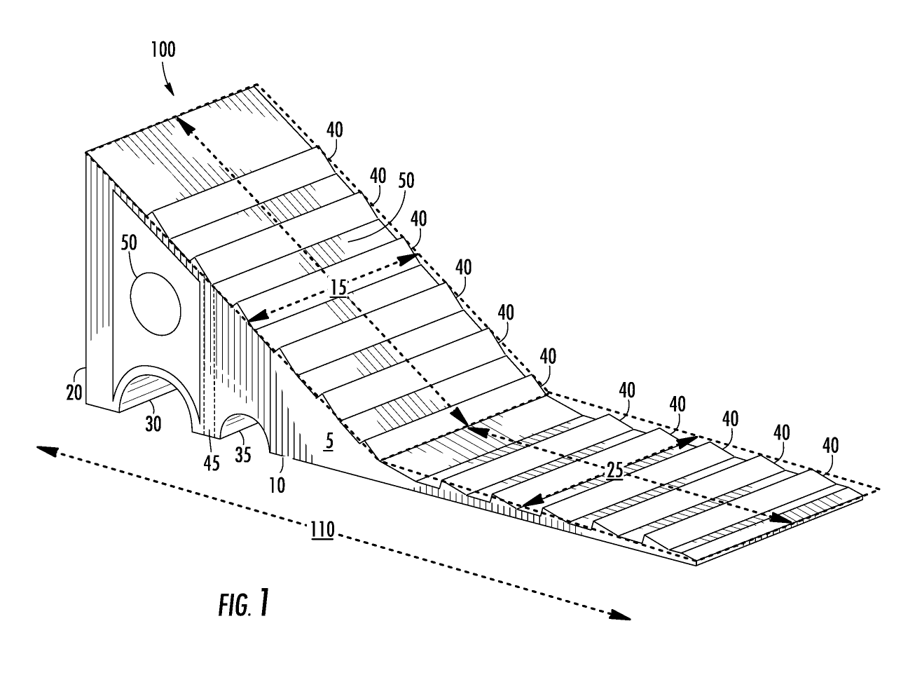

Referring to FIG. 1, a perspective view of a wheel chock 100 in accordance with an inventive embodiment is depicted. In this inventive embodiment, the wheel chock 100 includes a main body 5 having a base 10, an inclined tire engaging face 15 coupled with an upright back wall 20. The upright back wall 20 is joined with a high end of the inclined tire engaging face 25 and with the base 10 to form a generally wedge shaped structure. An auxiliary tire engaging face 25 extends outwardly from a low end of the inclined tire engaging face 15 opposite the upright back wall 20.

The auxiliary tire engaging face 25 is aligned in a plane 110 which parallels a long axis of the base 10 and has a generally planar cross sectional profile relative to the inclined tire engaging face 15. In one embodiment, the auxiliary tire engaging face 25 is an integral extension of the base 10.

A series of reticulations 40 may be provided on the inclined and/or auxiliary engaging faces 15, 25 to allow for greater traction of a tire when positioned thereupon.

The reticulations 40 are generally raised elongated structures disposed periodically on the inclined and/or auxiliary engaging faces 15, 25 and may be formed as part of the main body 5 or added thereafter.

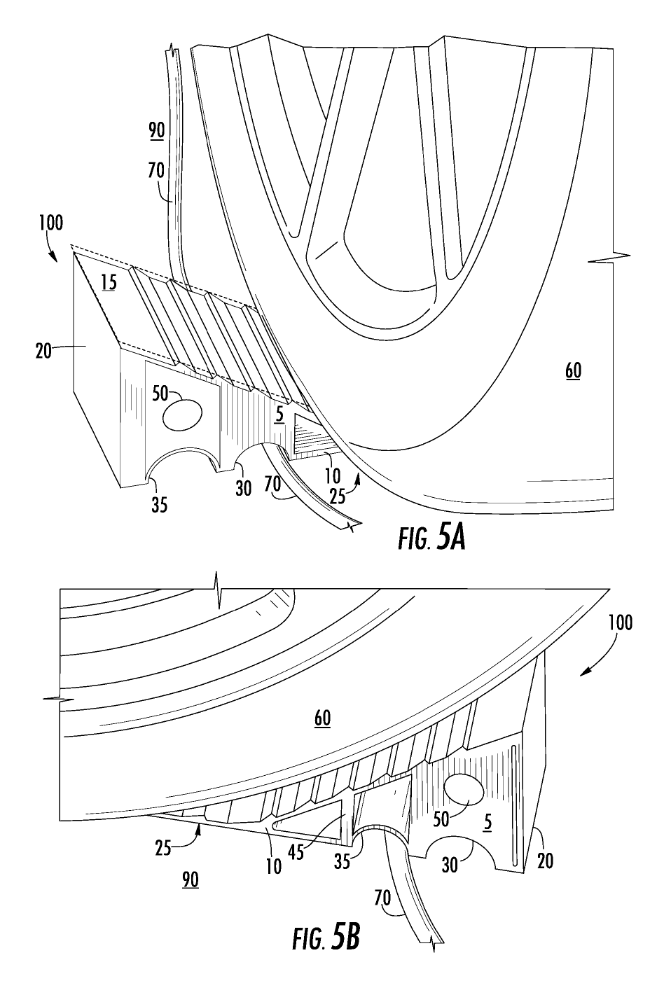

The main body 5 includes one or more conduits 30, 35, 50 dimensioned to receive an electrical cable therethrough. In one embodiment, one or more conduits 30, 35 are formed along the base 10 of the main body intermediate the upright back wall and the auxiliary tire engaging face 25. In this embodiment, the one or more conduits 30, 35 include a semi-circular cross sectional profile which form arches when the base 10 is disposed upon the support surface 90 (FIG. 5). The conduits 30, 35 are dimensioned to fully encompass a cross section of an electrical cable 70 (FIG. 5) to prevent crushing or otherwise damaging the electrical cable 70 (FIG. 5) when a tire of 60 (FIG. 5) of a vehicle 65 engages the wheel chock 100.

In an embodiment, the main body 5 may optionally be formed with one or more upright support towers 45 to improve load handling capability of the wheel chock 100.

In another embodiment, a separate conduit 50 may be provided intermediate the base 10 and the inclined tire engaging face 15. In this embodiment, the conduit 50 is dimensioned to axially receive therethrough an electrical cable 70 (FIG. 5) before an electrical plug 80 (FIG. 5) is installed on an end of the electrical cable 70 (FIG. 5). This arrangement allows for the wheel chock 100 to be permanently coupled with the electrical cable 70 (FIG. 5) to prevent loss or misplacement of the wheel chock 100. In this embodiment, the conduit 50 may be dimensioned so as to allow the wheel chock to slide along a length of the electrical cable 70 (FIG. 5) to simplify positioning with the tire 60 (FIG. 5) and/or electrical outlet (not shown).

The various conduits 30, 35, 50 are shown laterally aligned relative to a long dimension of the wheel chock 100 for convenience only. One having ordinary skill in the art will appreciate that other orientations of the conduits 30, 35, 50 may be employed so long as a portion of an electrical cable 70 (FIG. 5) is retained within the wheel chock 100 when a tire 60 is positioned at least upon the auxiliary tire engaging face 15.

The wheel chock 100 may be constructed using common construction techniques including injection molding, extrusion and/or machining from a block, bar or rod from any suitable generally rigid material. For example, polymers of acrylonitrile butadiene styrene (ABS), polyvinyl chloride (PVC), neoprene, ethylene propylene-diene monomer (EPDM), nylon and/or other thermoplastics having a Shore D hardness of at least 50. Alternately, the wheel chock 100 may be constructed from lightweight metals such as aluminum alloys, for example aircraft grade aluminum alloys T6062 or T6063. The main construction consideration is protecting the electrical cable 70 (FIG. 5) from being damaged when a vehicle engages or disengages the wheel chock.

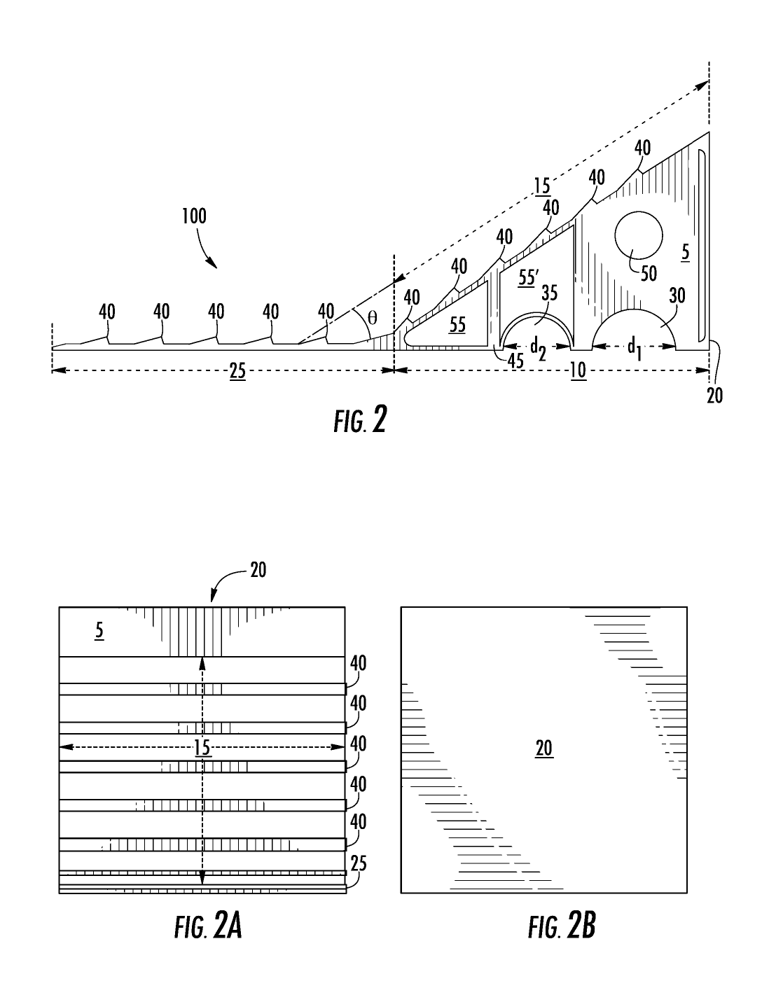

Referring to FIG. 2, a side view of a wheel chock 100 in accordance with an inventive embodiment is depicted. In this inventive embodiment, the main body 5 is shown with a partially hollow construction 55, 55′ on opposing sides of the optional upright support tower 45 in order to reduce the weight and construction cost of the wheel chock 100. In an embodiment, a long dimension of the auxiliary tire engaging face 25 is at least equal to a long dimension of the base 10. The long dimension of the auxiliary tire engaging face 25 allows sufficient surface area for a tire 60 (FIG. 5) to prevent the electrical cable 70 (FIG. 5) disposed in any of the conduits 30, 35, 50 from being removed from the wheel chock when anchored against the support surface 90 (FIG. 5).

In an embodiment, the cross sectional dimensions d1 and d2 of the conduits 30, 35 are different to accommodate different electrical cable dimensions. A close approximation of the cross-sectional dimension of the electrical cable with the cross sectional dimensions d1 and d2 of the conduits 30, 35 minimizes the possibility of the electrical cable 70 (FIG. 5) from becoming dislodged from the wheel chock 100 when the tire of the vehicle is being positioned upon the wheel chock 100. Typical diameters for the conduits 30, 35 are in a range of about 3-25 millimeters. One skilled in the art will appreciate that other conduit dimensions may be provided to accommodate a particular electrical cable dimension. The alternate conduit 50 does not require as close a fit to the cross sectional dimensions of the electrical cable 70 (FIG. 5) since the cable does is retained well above the support surface 90 (FIG. 5).

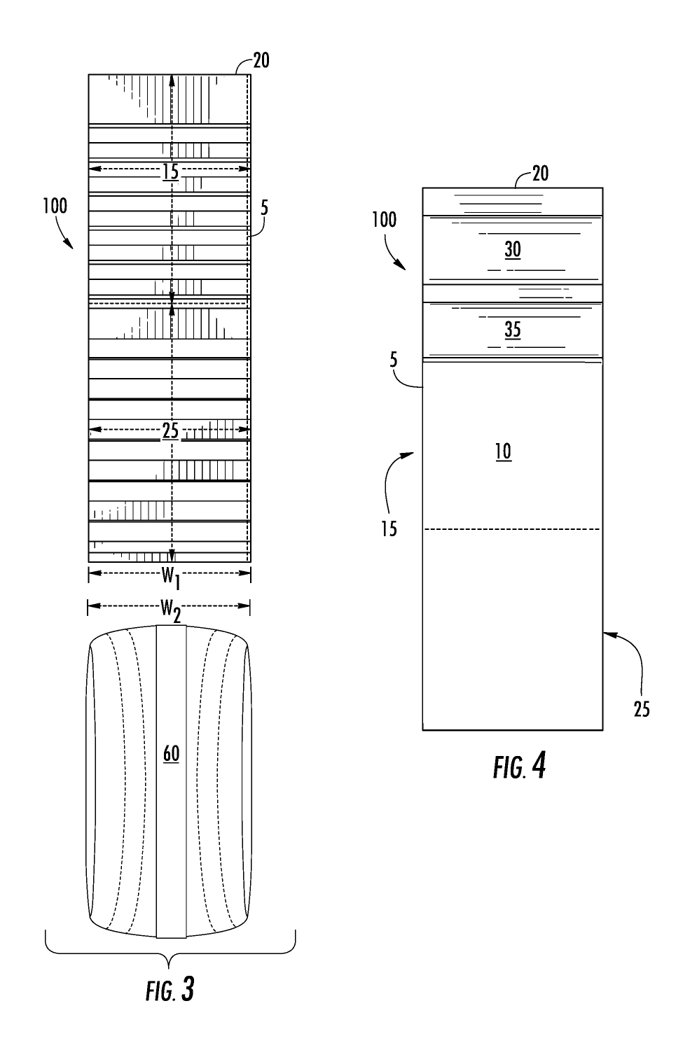

In an embodiment, the inclined tire engaging face 15 is sloped Θ in range from about 20-40 degrees relative to the base 5. The slope Θ is not critical for most implementations where the support surface 90 (FIG. 5) is generally horizontal and where sufficient structural support exists within the main body 5 to prevent damage to the electrical cable 70 (FIG. 5) when a vehicular tire 60 (FIG. 3) engages the wheel chock 100.

A portion of the auxiliary tire engaging face 25 may be sloped at about a common junction of the inclined tire engaging face 15 and the base 10.

Referring to FIGS. 2A and 2B, first and second end view of a wheel chock 100 in accordance with an inventive embodiment is depicted. In the first end view (FIG. 2A) the main body 5 is depicted when viewed from the auxiliary tire engaging face 25 end and illustrates the relationship of the inclined tire engaging face 15 with the generally planar cross sectional profile of the auxiliary tire engaging face 25. Surface reticulations 40 applied to the inclined tire engaging face 15 are visible as well. The upright back wall 20 is obscured from view by the inclined tire engaging face 15 in FIG. 2A and shown in FIG. 2B. The upright back wall 20 is provided with sufficient structural integrity to at least support the upper end of the inclined tire engaging face 15.

Referring to FIG. 3, a top view of a wheel chock 100 in accordance with an inventive embodiment is depicted. In this embodiment, the relationship of the inclined tire engaging face 15 and the auxiliary tire engaging face 25 portions of the main body 5 is illustrated. The inclined tire engaging face 15 is joined with the auxiliary tire engaging face 25 along a longitudinal axis centered with the inclined tire engaging face 15.

In an embodiment, a width W₁ of the wheel chock 100 is no greater than a width W₂ of a tire 60 intended to engage at least the auxiliary tire engaging face 25. The width relations W₁-W₂ allow for a compact wheel chock 100 which is easily handled and stored along with a reduction in construction costs.

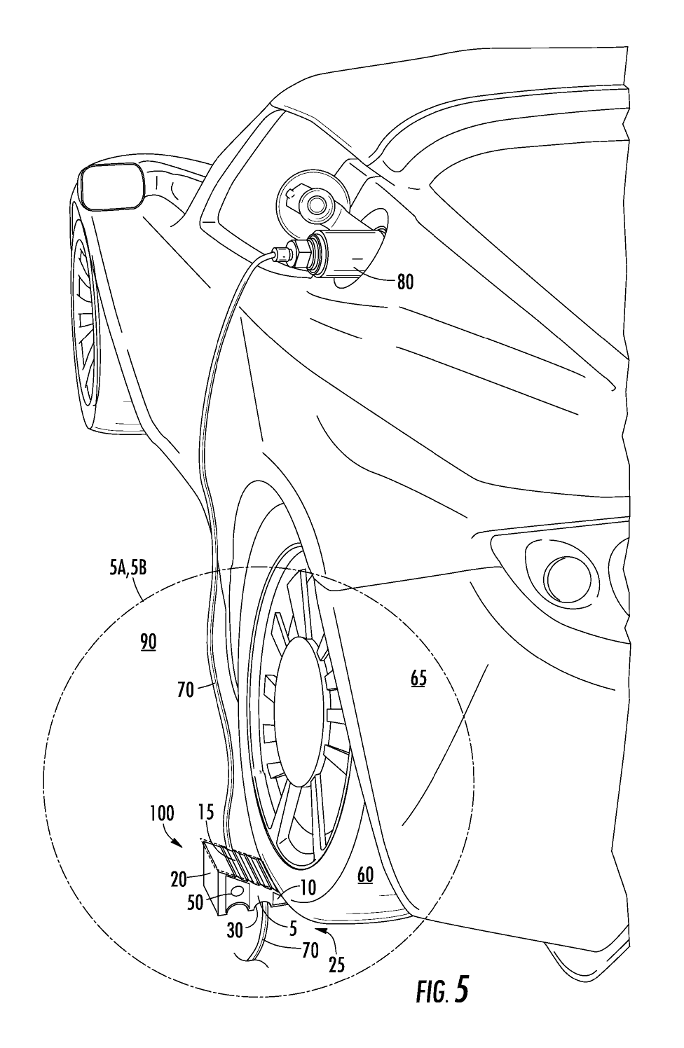

As previously discussed, a long dimension of the auxiliary tire engaging face 25 may be constructed to be at least equal to a long dimension of the base 10 (FIG. 4) in order to provide sufficient surface area in which the tire 60 engages to anchor the wheel chock against the support surface 90 (FIG. 5). One skilled in the art will appreciate that the dimensions of the wheel chock 100 may be varied to accommodate tire sizes of varying widths.

Referring to FIG. 4, a bottom view of a wheel chock 100 in accordance with an inventive embodiment is depicted. In this embodiment, the relationship of the base 10 with the inclined tire engaging face 15 and the auxiliary tire engaging face 25 portions of the main body 5 is shown where long dimensions of the auxiliary tire engaging face 25 and the portion of the base 10 underlying the inclined tire engaging face 15 are approximately equal. In addition, the positioning of the conduits 30, 35 is shown in relationship with the upright back wall 20, optional upright support tower 45 and base 10 included as part of the main body 5. Other aspects of the inventive embodiment are previously described.

Referring to FIG. 5, a perspective view of a wheel chock 100 when a tire 60 of a vehicle 65 is positioned on a portion thereon is depicted. In this embodiment, the wheel chock 100 has been previously positioned upon the support surface 90 with the electrical cable 70 disposed within one of the conduits 30. The wheel chock 100 is aligned to engage the tire 60 of the vehicle 65 generally perpendicularly to the long axis of the main body 5. The vehicle 65 is driven upon the wheel chock 100 until the tire 60 substantially covers at least the auxiliary tire engaging face 25.

The weight of the vehicle 65 applied to the wheel chock 100 through the tire 60 anchors the wheel chock 100 against the support surface 90. The cross-sectional dimension of the conduit 30 is considerably narrower than a cross section of a plug 80 used to recharge and/or trickle charge the onboard batteries which prevent removal of the electrical cable 70 from the wheel chock 100. While not shown, the opposing end of the electrical cable 70 also includes a plug having a cross sectional dimension likewise greater than that of the conduit 30. Thus, the only way to remove the electrical cable 70 without damaging it is disengage the vehicle from contact with the wheel chock 100.

As also depicted in FIG. 5, the tire 60 of the vehicle 65 is not restricted to solely engaging the auxiliary tire engaging face 25 of the main body 5. An outer edge of the tire 60 may also engage a portion of the inclined tire engaging face 15 in the illustrated orientation to provide greater weight distribution upon the wheel chock 100.

Insets shown in FIGS. 5A and 5B depict close up orientations of the wheel chock 100 with the respect to the tire 60 engaged with the main body 5. In FIG. 5A, a close-up view of the wheel chock 100 engaged in a generally perpendicular alignment with the tire 60 relative to the upright back wall 20. In this embodiment, the tire 60 has been positioned on the main body 5 such that a portion of the tire engages the inclined tire engaging face 15 and a substantial portion of the auxiliary tire engaging face 25.

In FIG. 5B, the tire 60 is depicted substantially engaging both the inclined and auxiliary tire engaging faces 15, 25 in a traditional long axis alignment with the wheel chock 100. Depending on inclinations in the support surface 90, the wheel chock 100 may be placed at the front or rear of the tire 60 to prevent movement induced by an inclined support surface 90. This arrangement provides the most secure retentive relationship with the electrical cable 70 where believed necessary by a user.

The various inventive embodiments described herein are intended to be merely illustrative of the principles underlying the inventive concept. It is therefore contemplated that various modifications of the disclosed embodiments will without departing from the inventive spirit and scope be apparent to persons of ordinary skill in the art. They are not intended to limit the various inventive embodiments to any precise form described. In particular, it is contemplated that the materials in which the wheel chock 100 is constructed from, placement of the various conduits and general dimensions may be varied to accommodate a particular design objective. Accordingly, no specific limitation is intended to a particular shape, conduit alignment or usage sequence described herein. Other variations and inventive embodiments are possible in light of the above teachings, and it is not intended that the inventive scope be limited by this specification, but rather by the Claims following herein.

What is claimed:

1. A wheel chock comprising:
a main body having,
a base;
an inclined tire engaging face;
an upright back wall coupled with the base and with the inclined tire engaging face;
an auxiliary tire engaging face extending outwardly from the inclined tire engaging face opposite the upright back wall, the auxiliary tire engaging face aligned in a plane which parallels the base; and,
a conduit dimensioned to receive an electrical cable, the conduit disposed within the main body such that at least a portion of the electrical cable when disposed therethrough is prevented from being removed therefrom when a tire of a vehicle is positioned at least upon the auxiliary tire engaging face.

2. The wheel chock of claim 1 wherein a long dimension of the auxiliary tire engaging face is at least equal to a long dimension of the base.

3. The wheel chock of claim 1 wherein the conduit is a channel formed in the base.

4. The wheel chock of claim 3 wherein the channel includes a semi-circular cross-sectional profile dimensioned to substantially encompass the electrical cable therein.

5. The wheel chock of claim 1 wherein the electrical cable is a recharging cable associated with one of a plug-in electric hybrid/ICE powered vehicle and an electrically powered vehicle.

6. The wheel chock of claim 1 wherein a width of the inclined tire engaging face is no greater than a width of the tire.

7. The wheel chock of claim 3 wherein the cross-sectional profile has a diameter in a range of about 3-25 millimeters.

8. A wheel chock comprising:
a main body formed from a generally rigid material having a unitary construction, the main body including;
a base;
an inclined tire engaging face;
an upright back wall coupled with the base and with the inclined tire engaging face;
an auxiliary tire engaging face extending outwardly from the inclined tire engaging face opposite the upright back wall and aligned in a plane which parallels the base; and,
a first conduit dimensioned to receive an electrical cable therethrough and aligned such that at least a portion of the electrical cable when disposed therein is prevented from being removed from the first conduit when a tire of a vehicle is positioned upon at least a substantial portion of the auxiliary tire engaging face.

9. The wheel chock of claim 8 wherein the main body further comprises a second conduit having a cross sectional dimension different than the first conduit.

10. The wheel chock of claim 9 wherein at least one of the conduits forms an archway along a portion of the base.

11. The wheel chock of claim 10 wherein the archway is dimensioned to encompass an electrical cable disposed therethrough in cooperation with a support surface.

12. The wheel chock of claim 8 wherein a cross section of the tire is disposed at an angle generally perpendicular to a long dimension of the auxiliary tire engaging face.

13. The wheel chock of claim 8 wherein at least the auxiliary tire engaging face includes a plurality of periodically spaced reticulations.

14. The wheel chock of claim 8 wherein a cross section of the tire is disposed at an angle generally parallel to a long dimension of the auxiliary tire engaging face.

15. The wheel chock of claim 8 wherein the auxiliary tire engaging face is integral with the base.

16. A wheel chock comprising:
a main body formed from a generally rigid material including,
a base;
an inclined tire engaging face;
an upright back wall coupled with the base and with the inclined tire engaging face;
an auxiliary tire engaging face extending outwardly from the inclined tire engaging face opposite the upright back wall, the auxiliary tire engaging face aligned in a plane which parallels the base and integral therewith; and,
a conduit dimensioned to axially receive an electrical cable and disposed along the base such that at least a portion of the electrical cable is retained within the conduit when a tire of a vehicle is positioned at least upon the auxiliary tire engaging face.

17. The wheel chock of claim 16 wherein the electrical cable is retained within the conduit in cooperation with a support surface in contact with the base.

18. The wheel chock of claim 16 wherein the main body includes an upright support tower disposed intermediate the upright back wall and a junction of the inclined tire engaging face and the auxiliary tire engaging face.

19. A method of using the wheel chock of claim 1 comprising:
disposing the electrical cable within the conduit;
placing the wheel chock containing the electrical conduit on a support surface in juxtaposition with the tire of a vehicle;
positioning the tire of the vehicle at least upon a substantial portion of at least the auxiliary tire engaging face.

20. The method claim 19 further comprising positioning the tire upon both the substantial portion of the auxiliary tire engaging face and at least a portion of the inclined tire engaging face.
